(19) United States
(12) Patent Application Publication
(10) Pub. No.: US 2023/0083473 A1
(43) Pub. Date: Mar. 16, 2023

(54) SHOVEL WITH REPLACEABLE BLADE

(71) Applicant: MUNSON INDUSTRIES, LLC, Poland, OH (US)

(72) Inventor: Patrick M. LEISTIKO, Poland, OH (US)

(21) Appl. No.: 17/930,908

(22) Filed: Sep. 9, 2022

Related U.S. Application Data
(60) Provisional application No. 63/242,608, filed on Sep. 10, 2021.

(51) Int. Cl. A01B 1/02; A01B 1/22

(52) U.S. Cl. CPC A01B 1/02; A01B 1/227

(57) ABSTRACT

A digging tool is described herein having a handle, the handle having a first end and a second end, fasteners, wherein the fasteners have a head and a body, and a blade, the blade have a front surface and a back surface, wherein the blade is removably attached to the second end of the handle via fasteners such that the head of the fastener is substantially flush with the back surface of the blade.

### I. Background

This application claims priority to U.S. Ser. No. 63/242,608, filed Sep. 10, 2021, the contents of which are incorporated herein by reference. The present teaching is directed to hand tools. More specifically, the present teaching is directed to digging tools with replaceable blades.

A shovel is a tool for digging, lifting, and moving bulk materials, such as soil, coal, gravel, snow, sand, or ore. Most shovels are hand tools consisting of a broad blade fixed to a medium-length handle. Shovel blades are usually made of sheet steel or hard plastics and are very strong. Shovel handles are usually made of wood (especially specific varieties such as ash or maple) or glass-reinforced plastic (fiberglass). Hand shovel blades made of sheet steel usually have a folded seam or hem at the back to make a socket for the handle. This fold also commonly provides extra rigidity to the blade. The handles are usually riveted in place. A T-piece is commonly fitted to the end of the handle to aid grip and control where the shovel is designed for moving soil and heavy materials. These designs can all be easily mass-produced.

A spade is a tool primarily for digging, comprising a blade—typically stunted and less curved than that of a shovel—and a long handle. Early spades were made of riven wood or of animal bones (often shoulder blades). After the art of metalworking was developed, spades were made with sharper tips of metal. Before the introduction of metal spades manual labor was less efficient at moving earth, with picks being required to break up the soil in addition to a spade for moving the dirt. With a metal tip, a spade can both break and move the earth in most situations, increasing efficiency.

Spades are made in many shapes and sizes, for a variety of different functions and jobs, and there are many different designs used in spade manufacturing. The most common spade is a garden spade, which typically has a long handle, is wide, and is treaded (has rests for the feet to drive the spade into the ground). An Irish spade is similar to a common garden spade, with the same general design, although it has a much thinner head. A sharpshooter is a narrow spade. A turfing iron has a short, round head, and is used for cutting and paring off turf. A digging fork, or grape, not referred to as a spade, is forked much like a pitchfork, and is useful for loosening ground and gardening. Small spades are made as toys for children.

Shovels and spades are made of similar basic parts—the handle, step, and blade—but they have subtle variances which might not look like much at first. Handle-Spade: shorter, straight handle with a D or T grip at the top to make it easy to hold. Shovel: long, upward-angled handle, often no grip at the top since shovels are usually held by the handle at an angle, not by the very top. Shovels do frequently have some type of padding around the upper section of the handle to make holding it more comfortable. Step-Spade: small ledge on top of the blade on either side of the handle, so that you can rest your foot on it and press down into the soil with the strength of your leg. Shovel: smaller or no step ledge, as shovels are not intended for the type of work that requires as much extra force of a foot on the blade (such as edging) and a bulky step would get in the way when scooping and lifting material at an angle. Blade-Spade: flat blade with a square-shaped end. Shovel: curved, bowl-shaped blade, usually rounded or pointed at the end, but shovels with square-shaped blades are available as well.

Shovel blades may become dull due to normal wear and tear or exposure to the elements. A dull blade will not cut through soil as easily as a sharpened one, which may cause increased exertion by the shovel's user.

Shovel blades may be re-sharpened, but at some point they will reach the end of their life cycle. Typically, a shovel is thrown away when the blade can no longer be sharpened.

### II. SUMMARY

In accordance with one aspect of the present teaching, a digging tool is provided with a replaceable blade.

In accordance with another aspect of the present teachings, different types of blades can be interchanged.

In accordance with another aspect of the present teachings, square holes can be used, such that the fastener heads can be flush with the blade face. The replacement blade can be attached to the receiving plate by fasteners, clips, hooks, or any other means chosen using sound engineering judgment.

Still other benefits and advantages of the present subject matter will become apparent to those skilled in the art to which it pertains upon a reading and understanding of the following detailed specification.

### III. BRIEF DESCRIPTION OF THE DRAWINGS

The present teachings are described hereinafter with reference to the accompanying drawings.

FIG. 1A is a front view of a handle for a digging tool;

FIG. 1B is a side view of the handle for a digging tool;

FIG. 1C depicts the yoke from FIGS. 1A and 1B;

FIG. 2A is a bottom view of a receiving plate;

FIG. 2B is a perspective view of the receiving plate;

FIG. 2C is a back view of the receiving plate;

FIG. 2D is a side view of the receiving plate;

FIG. 2E is a top view of the receiving plate;

FIG. 3A is a perspective view of a replacement blade;

FIG. 3B is a back view of the replacement blade;

FIG. 3C is a side view of the replacement blade;

FIG. 3D is a back view of the replacement blade;

FIG. 3E is a front view of the replacement blade;

FIG. 4A is a top view of a shovel with replacement blade;

FIG. 4B is a side view of the shovel with replacement blade;

FIG. 4C is a back view of the shovel with replacement blade;

FIG. 4D is a top view of the top of the shovel with replacement blade;

FIG. 4E is a perspective view of the shovel with replacement blade;

FIG. 5 is an exploded view of one of the openings on the receiving plate;

FIG. 6 is an exploded view of another aspect of one of the openings on the receiving plate;

FIG. 7 is a perspective view of a fastener;

FIG. 8 is a perspective view of a fastener with a square neck;

FIG. 9 is a perspective view of another fastener;

FIG. 10 is a top view of another receiving plate;

FIG. 11 is a side view of the receiving plate in FIG. 10; and

FIG. 12 is a bottom view the receiving plate in FIG. 10 attached to the yoke.

### IV. DETAILED DESCRIPTION

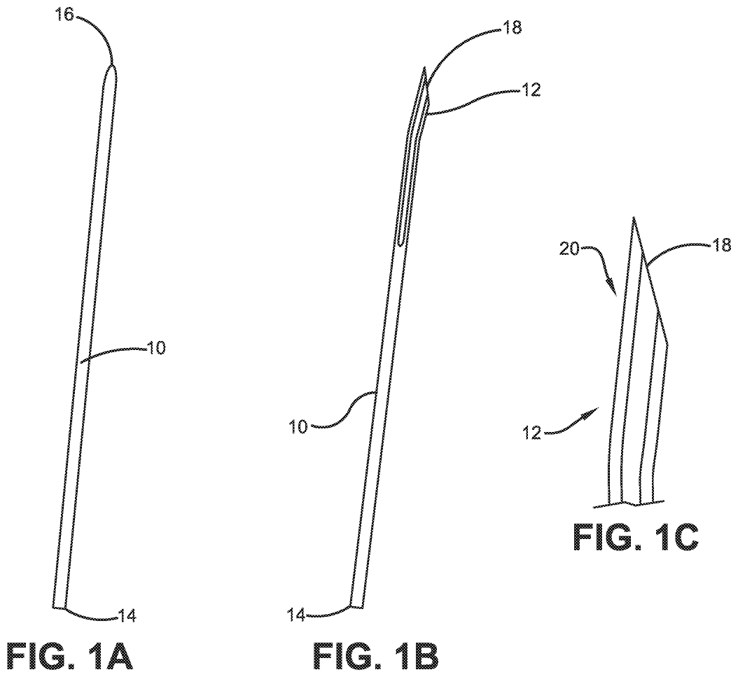

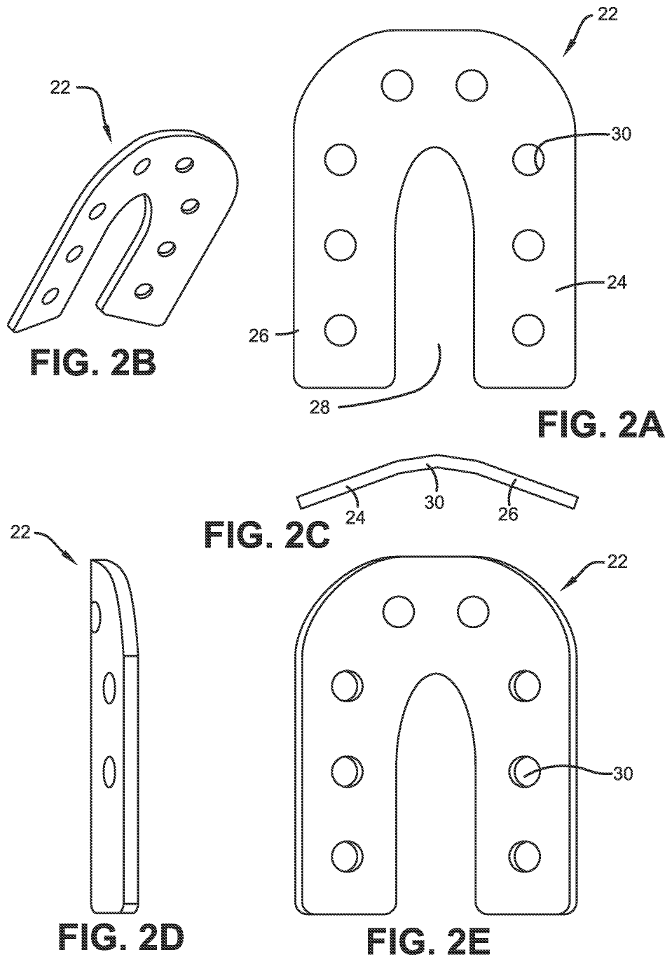

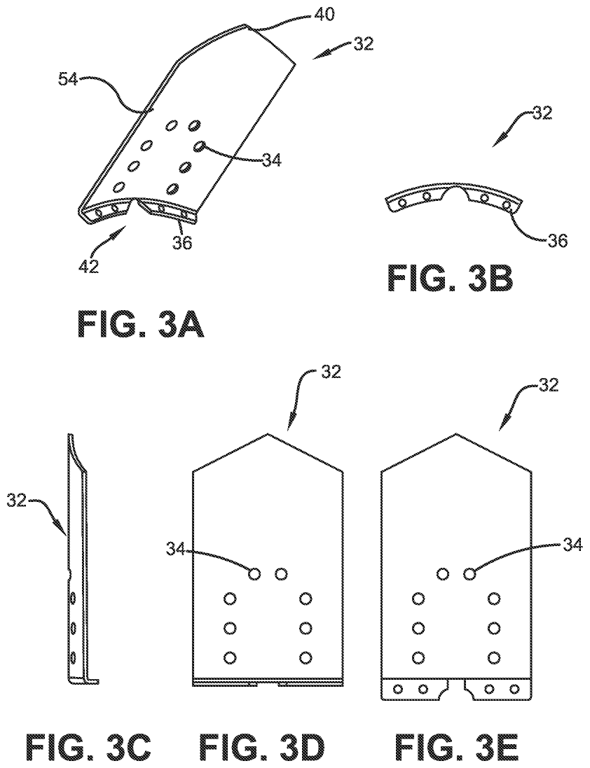

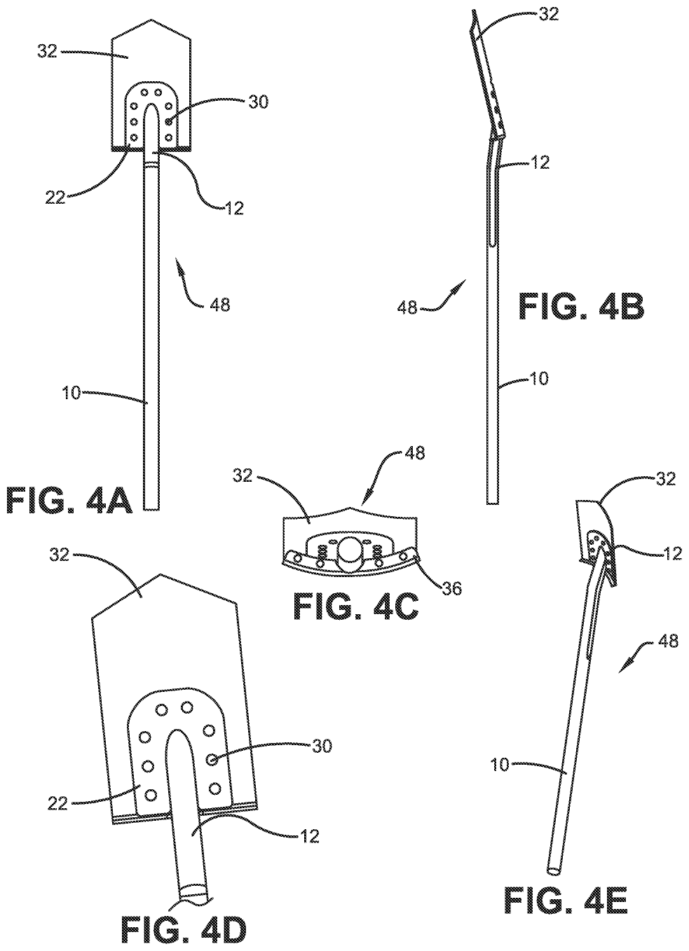

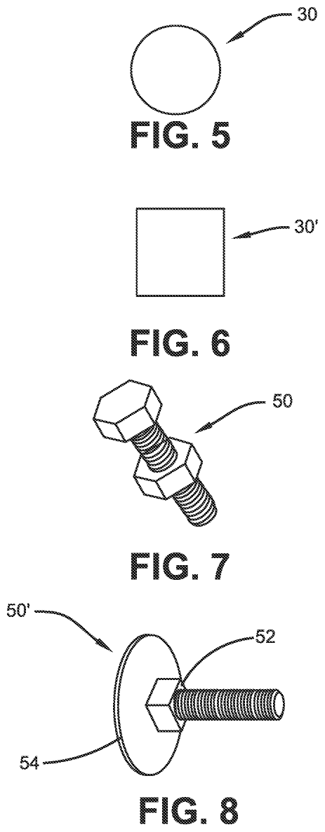

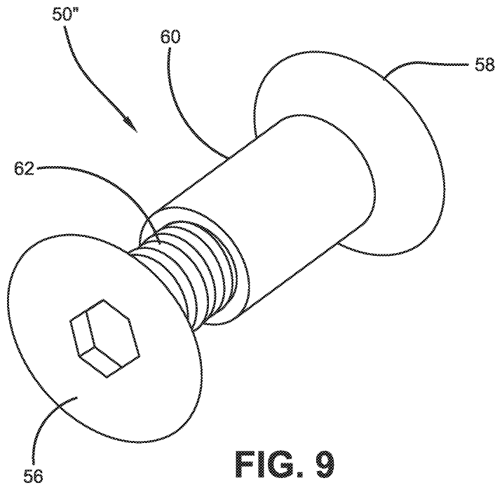

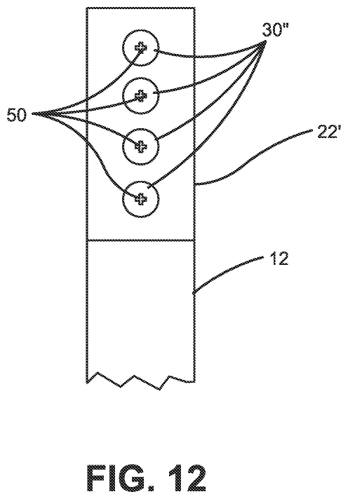

With reference to FIGS. 1-12, in one aspect of the present teaching, a digging tool 48 has a handle 10, a yoke 12, an angled portion 20, a receiving plate 22, and a blade 32. The yoke 12 and the handle 10 can form a contiguous unit, the handle 10 having a first end 14 and a second end 16, with the yoke 12 being at the second end 16 of the handle 10. The yoke 12 can either receive the blade 32 itself or the receiving plate 22. In one aspect of the present teachings, the angled portion 20 is angled to receive the receiving plate 22. The angled portion 20 has an angled face 18 at one end that is attached to the receiving plate 22. The yoke 12 and receiving plate 22 are fixedly attached to one another. The yoke 12 and receiving plate 22 can be press fit, welded, or connected together in any other manner using sound engineering judgment. The receiving plate 22 is substantially u-shaped, with a middle portion 28 for receiving the angled portion 20. The receiving plate 22 also has a series of openings 30 for receiving fasteners 50 to attach the blade 32. In one aspect of the present teachings, the receiving plate 22 has two side flanges 24, 26 that angle downwardly away from a central portion 30. The angled portion 20 is fixedly attached to the second end 16 of the handle 10. The angled face 18 of the angled portion 20 fits into the middle portion 28 of the receiving plate 22, and the angled portion 20 is fixedly attached to the receiving plate 22. The blade 32 is attached to the receiving plate 22 via openings 30 and 34 using fasteners 50.

With continuing reference to FIGS. 1-12, the receiving plate 22 can be any shape chosen using sound engineering judgment. It is also to be understood that the handle 10 does not have to have a yoke 12. The handle 10 can connect directly to the receiving plate 22. The handle 10 and/or yoke 12 can either be fixedly attached to the receiving plate or selectively attached to the receiving plate 22. When the handle 10 is selectively attached to the receiving plate 22, the handle 10 can also be replaced when worn out, or if a different handle type is desired. It is also to be understood that the receiving plate 22 and replacement blade 32 can be flat or angled to any degree desired, as long as chosen using sound engineering judgment.

With continuing reference to FIGS. 1-12, the replacement blade 32 has a series of openings 34 to match the openings 30 on the receiving plate 22. The replacement blade 32 and the receiving plate 22 are connected together with selectively removable fasteners 50. The openings 30 in the receiving plate 22 and the blade 32 can be circular openings 30 or square openings 30′. In one aspect of the present teachings, the square openings 30′ allow for square fasteners 50′, which can have substantially flush heads 54 and a square neck 52, such that the back surface 54 of the blade 32 is substantially smooth. The square neck 52 fits in the square opening 30′, enabling a more secure fit of the fastener 50′. Another fastener 50″ is shown in FIG. 9, with a head 56, a bottom 58, a barrel 60, and a threaded portion 62. The blade 32 can be angled to match the angle of the receiving plate 22. The replacement blade 32 can also have a top flange 36, which can accept a rubber bumper (not shown). The replacement blade 32 can have different types of attachment. The number of openings 30, 30′ in the replacement blade 32 can be as many as needed, or as few as one. The openings 30, 30′ can be any shape.

In one aspect of the present teachings, the handle 10, yoke 12, receiving plate 22, and blade 32 can all be made of metal, such as steel or aluminum, with the handle 10, yoke 12, and receiving plate 22 all being welded together. However, it is to be understood that the components can be made of other materials, such as wood or plastic, or any combination of materials, and can be connected via mechanical means, press fit, attached via adhesive, or any other attachment mechanism chosen using sound engineering judgment.

With continuing reference to FIGS. 1-12, the replacement blade 32 does not have to be a shovel, but can be any type of digging tool blade.

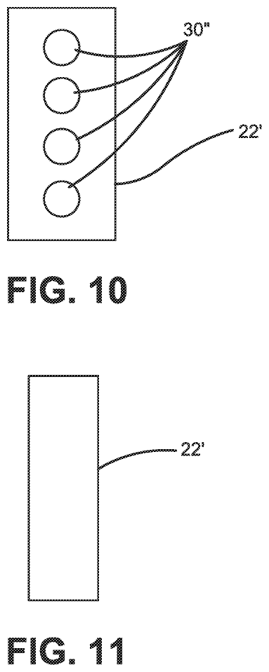

With continuing reference to FIGS. 10-12, another aspect of the present teachings has a different shape for the receiving plate 22′. The receiving plate 22′ has openings 30″ for receiving the fasteners 50. The receiving plate 22′ can be welded directly to the handle 10 or yoke 12. The replacement blade 32 can then be attached to the receiving plate 22′.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Having thus described the present teachings, it is now claimed:

1. A digging tool comprising:
a handle, the handle having a first end and a second end;
a yoke, the yoke being at the second end of the handle;
a receiving plate, the receiving plate being substantially u-shaped to accept the yoke, wherein the receiving plate is fixedly attached to the yoke, wherein the receiving plate has multiple openings;
fasteners, wherein the fasteners have a head and a body;
a blade, the blade have a front surface and a back surface, wherein the blade has openings corresponding to the openings on the receiving plate, wherein the blade is removably attached to the receiving plate via the fasteners such that the head of the fastener is substantially flush with the back surface of the blade.

2. The digging tool of claim 1, wherein the second end of the handle has an angled portion having an angled face, wherein the angled face is fixedly attached to the receiving plate.

3. The digging tool of claim 2, wherein the openings are substantially square, wherein the fasteners having a correspondingly shaped square neck.

4. The digging tool of claim 3, wherein the blade has a top and a bottom, wherein the bottom has an inwardly facing flange.

5. A digging tool comprising:
a handle, the handle having a first end and a second end;
fasteners, wherein the fasteners have a head and a body; and
a blade, the blade have a front surface and a back surface, wherein the blade is removably attached to the second end of the handle via fasteners such that the head of the fastener is substantially flush with the back surface of the blade.

6. The digging tool of claim 5, wherein the digging tool further comprises:
a receiving plate, wherein the receiving plate is fixedly attached to the second end of the handle, and the blade is removably attached to the receiving plate.

7. The digging tool of claim 6, wherein the receiving plate and the blade have matching openings through which the fasteners attach.

8. The digging tool of claim 7, wherein the second end of the handle has an angled portion having an angled face, wherein the angled face is fixedly attached to the receiving plate.

9. The digging tool of claim 8, wherein the receiving plate is substantially u-shaped, wherein the receiving plate has multiple openings, wherein the blade has openings corresponding to the openings on the receiving plate.

10. The digging tool of claim 9, wherein the openings are substantially square, wherein the fasteners having a correspondingly shaped square neck.

11. The digging tool of claim 10, wherein the blade has a top and a bottom, wherein the bottom has an inwardly facing flange.

12. A method for replacing a blade on a digging tool, the method comprising the steps of:
providing a handle, the handle having a first end and a second end;
providing fasteners, wherein the fasteners have a head and a body;
removing the fasteners from a first blade, the first blade have a front surface and a back surface, wherein the first blade being removably attached to the second end of the handle via fasteners such that the head of the fastener is substantially flush with the back surface of the first blade; and
attaching a second blade, the second blade have a front surface and a back surface, wherein the second blade being removably attached to the second end of the handle via fasteners such that the head of the fastener is substantially flush with the back surface of the second blade.

13. The method of claim 12, wherein the digging tool further comprises:
a receiving plate, wherein the receiving plate is fixedly attached to the second end of the handle, and the first or second blade is removably attached to the receiving plate.

14. The method of claim 13, wherein the receiving plate and the first and second blades have matching openings through which the fasteners attach.

15. The method of claim 14, wherein the second end of the handle has an angled portion having an angled face, wherein the angled face is fixedly attached to the receiving plate.

16. The method of claim 15, wherein the receiving plate is substantially u-shaped, wherein the receiving plate has multiple openings, wherein the first and second blades have openings corresponding to the openings on the receiving plate.

17. The method of claim 12, wherein the openings are substantially square, wherein the fasteners having a correspondingly shaped square neck.

18. The method of claim 12, wherein the first and second blades have a top and a bottom, wherein the bottom has an inwardly facing flange.
